(19) United States
(12) Patent Application Publication
(10) Pub. No.: US 2011/0115246 A1
(43) Pub. Date: May 19, 2011

(54) RETRACTABLE SAFETY COVER FOR A RAIL SYSTEM IN A MOTOR VEHICLE

(75) Inventor: Kurt BEYER, Wiesbaden (DE)

(73) Assignee: GM GLOBAL TECHNOLOGY OPERATIONS, INC., Detroit, MI (US)

(21) Appl. No.: 12/943,415

(22) Filed: Nov. 10, 2010

(30) Foreign Application Priority Data
Nov. 11, 2009 (DE) 102009052692.7

(51) Int. Cl. B60R 7/04; B65D 51/00

(52) U.S. Cl. 296/24.34; 220/812

(57) ABSTRACT

A motor vehicle is provided with a rail system having a cover device for a rail system resembling a Roman blind, with several interconnected, telescoping, lamellar segments, which laterally at least partially exhibit guide elements for engaging guide grooves of the rail system. The guide elements are at least partially variable in length, so that an overall width of the cover device transverse to the progression of the guide grooves can be diminished for removal and insertion from and in the rail system.

### CROSS-REFERENCE TO RELATED APPLICATION

This application claims priority to German Patent Application No. 102009052692.7, filed Nov. 11, 2009, which is incorporated herein by reference in its entirety.

### TECHNICAL FIELD

The invention relates to a cover device for a rail system resembling a Roman blind, a rail system for a motor vehicle, in particular for a center console space of a motor vehicle, and a motor vehicle.

### BACKGROUND

Known in the art are various covers and blinds for covering compartments. Also known from DE 196 46 809 A1 is a cover with a roller blind. Arranged under lateral end sections of the roller blind for covering an opening in a center console of a motor vehicle are webs, which engage underlying guide elements. The covered guides make it possible for the roller blind to directly reach the edge of the opening in the center console.

Known from DE 42 20 670 is a closable container for holding a car phone and other objects, such as ashtrays, cigarette lighters and the like, in particular to be arranged on the center console in the motor vehicle. In order to achieve an aesthetically appealing cover design in conjunction with an automatic transfer of the car phone into or out of container when closing or opening the container, the container opening is covered with a sliding blind that can slide in the longitudinal direction of the container, and the car phone is secured to a support console pivoted inside the container. A pivot unit is secured to the sliding blind to swivel the support console in and out, and securely bonded with the support console by means of a coupling after a predetermined sliding path of the sliding blind. When swiveled in, the support console is latched by means of a latching unit combined with the coupling in such a way that the latched support console is unlatched after the coupling closes, and vice versa before the coupling is released.

In view of the foregoing, at least one object is to provide a motor vehicle with a storage compartment that can be reliably covered, and is integrated into the motor vehicle in an optically appropriate way. At least another object is to provide a flexible cover device for a cargo space in a rail system that ensures streamlined protection for objects placed therein. In addition, other objects, desirable features and characteristics will become apparent from the subsequent summary and detailed description, and the appended claims, taken in conjunction with the accompanying drawings and this background.

### SUMMARY

A cover device is provided for a rail system resembling a Roman blind with several interconnected, telescoping, lamellar segments, which laterally at least partially exhibit guide elements for engaging guide grooves of the rail system, it is provided that the guide elements be at least partially variable in length, so that an overall width of the cover device transverse to the progression of the guide grooves can be diminished for removal and insertion from and in the rail system. Designated as the Roman blind in terms of an embodiment of the invention is a cover device with lamellae, which are telescopically and/or foldably interconnected in the longitudinal direction of the cover device. The cover device is designed like a Roman blind, and has several segments coupled together that resemble lamellae. The lamellae are stiff and hinged together. The lamellae here exhibit a greater extension in a transverse direction of the cover device than in a longitudinal direction of the cover device. The depth of the lamellae can be varied depending on the strength of the lamellae desired. At least some lamellae have guide elements laterally, meaning at edges that border the cover device in a transverse direction, which project from the lamellae in the transverse direction of the cover device for accommodation in a corresponding guide groove. The guide elements are variable in terms of their lateral extension or length, for example via shifting or shaping. In one embodiment, the guide elements can be inserted and extended, preferably by way of a corresponding mechanism. In this way, the lamellae can be transversely removed from the guide grooves. The lamellae are arranged in a rail system. The rail system preferably has two parallel, spaced rails or rail units. The constant distance between the rails preferably corresponds to roughly the width of the lamellae, meaning their extension in the transverse direction, without the guide elements. The overall extension of the lamellae including the guide elements with maximal extension is greater than the distance between the rails. In this way, the guide elements project into the corresponding guide grooves in the rails, so that the lamellae are guided between the rails. In one embodiment, the rails exhibit several guide grooves, so that the cover device can traverse several planes. The guide grooves not occupied by the cover device are designed to accommodate other objects in another embodiment, which can be accommodated in the guide grooves via corresponding guide elements. Additional latching means make it possible to secure the other objects on the rail system. The function of the cover device is preferably not or just insignificantly impaired when additional objects are accommodated.

One embodiment provides that at least one lamellar segment or one lamella exhibits an accommodating section on its upper surface. An accommodating section is formed on the upper side of at least one of the lamellae for stowing smaller objects, such as coins or keys, which are easily lost in a larger storage compartment. The accommodating section is designed as a depression, thereby forming a shell-like storage tray. For example, several lamellae are provided with such accommodating sections. In advantageous embodiments, lamellae with accommodating sections are wider and/or deeper than lamellae without accommodating sections. In an advantageous embodiment of the invention, the accommodating section is designed in such a way as to also serve as a handle for shifting the cover device. Additional control units are provided in other embodiments.

Another embodiment provides that a lid element is arranged on the accommodating section. In order to prevent smaller objects in the accommodating section from being lost, a lid is provided on the accommodating section, covering an upper opening of the accommodating section. The lid can fold or slide. The sliding lid element ensures a flat design. The lid element is preferably provided with a slight depression, thereby providing an additional option for holding small objects. For example, the depression has a handle area, which can be sued to operate the lid element.

Yet another embodiment provides that there be a locking device, with which the cover device in the rail system can be sealed. In advantageous embodiments, the locking device prevents the guide elements from undergoing any changes in length and/or the cover device from becoming opened by sliding together the lamellar segments. The locking device is preferably designed as a closure system, which can be separately locked with a key. In other exemplary embodiment, the closure system is coupled to other devices of a motor vehicle, for example to an ignition or door lock. In this way, closure takes place by activating the other device.

In another embodiment, the lamellar segments or lamellae consist at least partially of an opaque material. The opaque design prevents any unwanted glimpses under the cover device. As a result, valuables can be kept hidden away form third parties in the motor vehicle under the cover device inside the motor vehicle. In addition, the material for the lamellae is burglary resistant or proof, so that the cover device enables the creation of a kind of safe or lockbox in the motor vehicle.

A rail system is also provided for a motor vehicle, in particular for a center console space of a motor vehicle, comprising two interacting rail units spaced apart from each other, the facing sides of which have at least one guide groove, and at least one cover device, which is guided between the rails with guide elements in the guide grooves, it is provided that the cover device is designed as a cover device. The rail system has two rail units or rails, which extend in a floor area in roughly a central arm console region in the longitudinal direction of the vehicle. The rails preferably trace an arc, wherein the distance from the floor area increases in the direction of the cockpit area. In this way, the rails traverse a cargo space between and under the rails, which can be covered from above by the cover device. The guide grooves also mirror the rail progression, so that the cover device resembling a Roman blind and guided in the guide grooves can move along the arced region. The lamellae of the cover device can slide together, sot that they can be placed in a narrow space on the cargo space to open an access opening. Moving apart the cover device collapsed like a fan makes it possible to cover the top of the cargo space. The sides of the cargo space are covered by walls, so that the opening that accommodates the cover device forms the only access opening. In advantageous embodiments, the walls of the cargo space consist of existing structures of the motor vehicle, such as motor vehicle seats.

Another embodiment provides that each rail unit has several guide grooves for guiding the cover device in varying planes. The rails have several guide grooves to provide different planes to accommodate the cover device and other objects. This yields a multifunctional rail system.

Yet another embodiment provides that the guide grooves run spaced apart from a floor area, thereby yielding a cargo space between the floor area and rail units or rails that can be at least partially covered by the cover device. The cargo space traversed by the rails can be divided into separate planes by the varying guide grooves. The separate planes can accommodate different objects and devices, such as the cover device and, for example, a central arm console or other items. The objects here infringe on each other to an insignificant extent, if at all.

In yet another advantageous embodiment, the rail units have connecting elements for attaching accessories. In order to secure accessories or other objects to the rail system in a reliable, in particular crash-proof manner, connecting element such as latching elements, locking elements and the like are provided. A corresponding latching device is necessary precisely for cases where an object is not to be slidably arranged in the guide grooves. The latter can be realized by means of screws, guide pins, clips or other connecting elements.

A motor vehicle is provided having a passenger compartment; it is provided that at least one rail system is arranged in the passenger compartment. The rail system is preferably arranged close to the floor in a central arm console region. The rail system can be suitably arranged in different ways. For example, the rail system is arranged proximate to the roof and/or transverse to a longitudinal direction of the vehicle. In other embodiments, two rail systems are situated side by side. In turn, the rail systems extend in a loading space in other exemplary embodiments.

Features or components of different embodiments can be combined, so as to yield additional embodiments. All features and/or advantages arising from the claims of the descriptions or drawings, including structural details, spatial arrangements and procedural steps, can be significant whether taken separately or in a variety of combinations.

### BRIEF DESCRIPTION OF THE DRAWINGS

The present invention will hereinafter be described in conjunction with the following drawing figures, wherein like numerals denote like elements, and:

FIG. 1 is a diagrammatic, perspective view of a rail system with a cover device in a half-closed position;

FIG. 2 is a diagrammatic, perspective view of the rail system according to FIG. 1 with a cover device in a closed position;

FIG. 3 is a diagrammatic, perspective view of a rail system similar to FIG. 1 with a cover device in the half-closed position;

FIG. 4 is a diagrammatic, perspective view of a rail system similar to FIG. 1 with a cover device and an accessory element is secured to the rail system;

FIG. 5 is a diagrammatic, perspective view of another exemplary embodiment of a rail system with the cover device in a half-closed position in a second guide groove;

FIG. 6 is a diagrammatic, perspective view of the rail system according to FIG. 5 in a closed position;

FIG. 7 is a diagrammatic, perspective view of the rail system according to FIG. 6 with an object arranged on the rail system, and

FIG. 8 is a diagrammatic, side view of the rail system according to FIG. 7.

### DETAILED DESCRIPTION

The following detailed description is merely exemplary in nature and is not intended to limit application and uses. Furthermore, there is no intention to be bound by any theory presented in the preceding background or summary or the following detailed description.

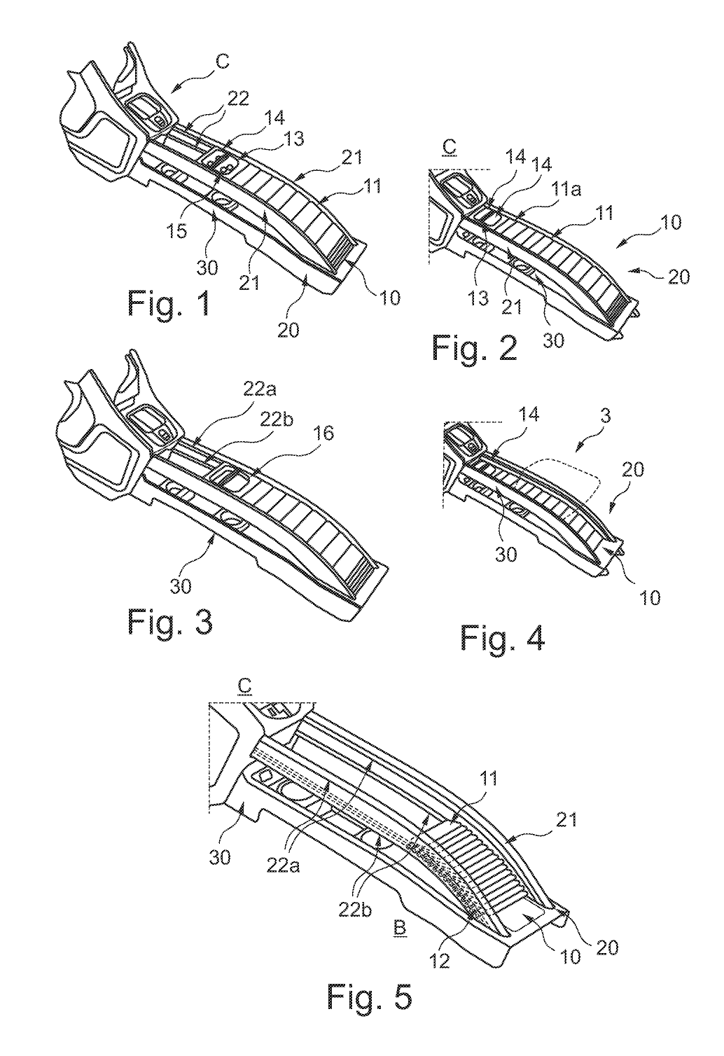

FIG. 1 to FIG. 8 show exemplary embodiments of a cover device 10, which is arranged in a rail system 20. The rail system 20 is located in a central console space in a motor vehicle (not shown), and extends in an arc starting from a rear floor area. The distance from the floor area increases in a vertical direction in an arced progression toward a cockpit area C. In the area adjacent to the cockpit area C, the rail system 20 proceeds roughly parallel in a vertical direction relative to the floor area. The rail system 20 encompasses two correspondingly arced rails 21 spaced parallel apart from each other.

The rails 21 each exhibit two guide grooves or guide paths 22 spaced apart from each other. The guide grooves 22 are arranged in such a way that they correspond to the respective other guide groove 22 of the other rail 21. The cover device 10 is collapsible like a Roman blind, and for this purpose exhibits several lamellae 11 arranged in series in a longitudinal direction or extension direction of the rail system. The lamellae 11 extend essentially in a transverse direction of the cover device, i.e., transverse to an opening and closing direction, so that they can be guided between the two rails 21 of the rail system 20. In order to guide the cover device 10 between the rails 21, the lamellae 11 have corresponding guide elements 12, which correspond to the guide grooves 22. For example, the guide elements 12 are visible on FIGS. 4 to 6. The guide elements 12 are at least partially longitudinally variable, so that an entire width of the cover device 10 can be altered. The guide elements 22 projecting on the side of the cover device 10 are retractable, so that the cover device 10 can be inserted and removed between the rails. To this end, a corresponding mechanism is provided, which at least partially retracts the guide elements 22 laterally. The guide elements are elastic in other embodiments, so that the latter can be correspondingly bent for their lateral removal or insertion from and into the guide grooves.

The lamellae can be made out of any material desired. In one embodiment, the lamellae are made out of an aluminum material. In other embodiments, the lamellae are made out of a plastic material. Still other embodiments provide that the lamellae consist of a textile material. Individual lamellae can be fabricated with varying materials. Opaque materials are preferably provided. Materials resistant to breakage are also preferably used. The lamellae are given various shapes in an exemplary embodiment.

In the exemplary embodiments shown on FIG. 1 to FIG. 4, the surface of a lamella 11a is provided with an accommodating section 14. The accommodating section 14 encompasses two depressions in the lamella 11a, and provides space for accommodating smaller objects 15, such as coins, keys or the like. To this end, at least the lamella 11a has a sufficient depth. In order to reliably store the smaller objects, other configurations provide a lid element (not shown). The accommodating section 14 are separated by a web, which serves as a handle area 13. The handle area 13 makes it possible to grip and move the lamella 11a, and thereby shift the cover device 10. As a result, the entire cover device 10 can be actuated via the handle area 13. By gripping the handle area 13 and moving the handle area 13 toward the cockpit area C, the cover device 10 can in this way be moved from the half-closed position depicted on FIG. 1 and FIG. 3 to the closed position shown on FIG. 2 and FIG. 4. In the closed position, the interstice is not visible from the direction of the cover device 10.

In addition, the cover device 10 in the exemplary embodiment depicted on FIG. 3 is lockable. This means that the cover device 10 has a locking element 16 that can be engaged with a corresponding locking element in the cockpit area C and/or on the rail system 20, and performs a burglary resistant or proof function.

The lateral area under the rails 21 openly visible in the figures is at least partially covered when the motor vehicle seats are ready to use. The cover device 10 can preferably be moved via the handle area 13.

The cover device 10 on FIG. 4 is guided in a second guide groove 22b, which is situated under the guide groove 22a fitted with the guide elements 22 in the preceding drawings. The cover device 10 is situated deeper in relation to an upper side of the rails 21. Given the larger offset in relation to the upper side of the rails 21, another object or accessory element 3 can be attached via the cover device 10, which has affects the function of the cover device 10 insignificantly, if at all. For example, the accessory element 3 is arranged in the upper guide groove 22a, as depicted on FIG. 4. The flat cover device 10 situated or guided in the lower guide groove 22b can effortlessly traverse the region under the object. As also depicted on FIG. 4, the cover device 10 can be opened in both directions, meaning from the back and front. To enable back to front movement, another lamella is preferably provided as a handle element or with a handle element.

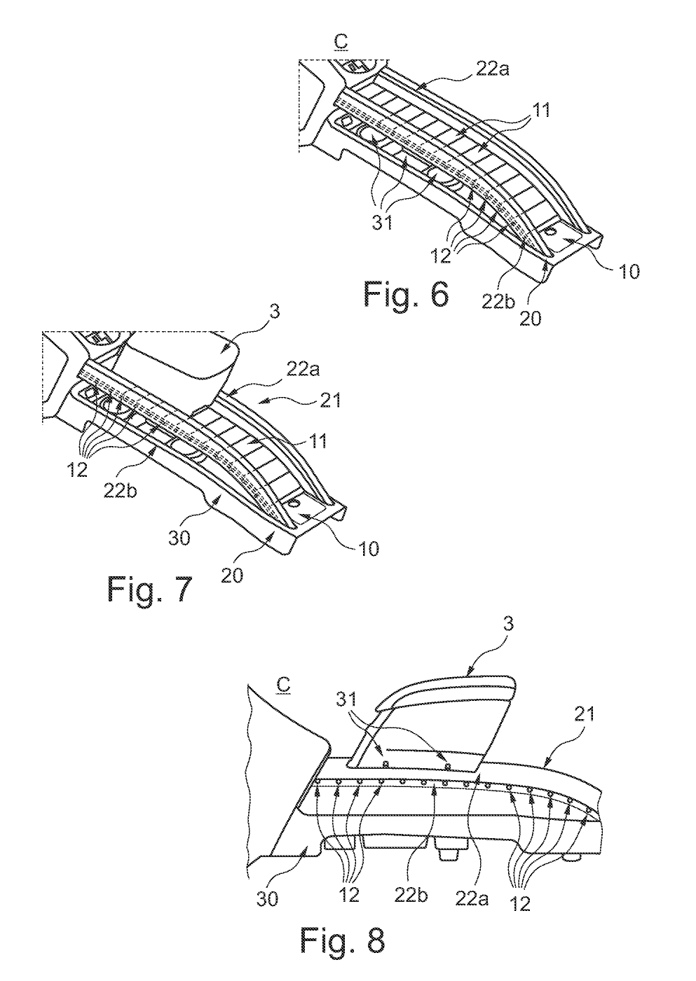

In other exemplary embodiments, e.g., the ones depicted on FIG. 5 to FIG. 8, shifting takes place without a handle area 13. The cover device 10 can here be shifted between an open position depicted on FIG. 5 and a closed position depicted on FIG. 6. For example, shifting here takes place directly by applying force to the lamellae 11, wherein the latter exhibit a slip-proof surface for this purpose in one configuration.

Preferably arranged under the cover device 10 between the rails 21 is a storage unit 30 on the floor region. The storage unit 30 is described in greater detail in reference to FIG. 6. For example, as also visible on FIG. 6, the storage unit 30 has depressions 31 to accommodate objects like beverage containers, coins, keys and the like. The cover device 10 on FIG. 6 is guided in the lower guide groove 22b.

As evident from FIG. 6, each lamella 11 has pin-like guide elements 12, which engage the guide groove 22b. The guide elements 12 are preferably designed as cylinder pins, so as to realize good guiding characteristics in the guide grooves 22. Arranging the cover device 10 in the lower guide groove 22b creates enough space for accommodating an object or accessory element 3 in or at the upper guide groove 22a, as depicted on FIG. 7. The accessory element 3 is designed as a central arm console, which exhibits an integrated storage compartment. The accessory element 3 is connected in the upper guide groove 22a. Additional latching elements prevent any unintended movement of the accessory element 3. In the constellation shown on FIG. 7, the cover device 10 is ready for operation, and can be collapsed for opening purposes. The cover device 10 can be folded together under the object owing to its flat configuration.

The lateral view shown on FIG. 8 illustrates the arrangement and progression of the guide paths more clearly. While the guide groove 22a runs adjacent to an upper side of the rail 21, the lower guide groove 22b runs adjacent to a lower side of the rail 21, meaning close to the floor. The accessory element 3 is accommodated in the upper guide groove 22a by means of pins 31. Without latching elements, the accessory element 3 can be shifted into the upper guide groove 22a. Latching elements are provided to secure the accessory element 3. Guide elements 12 allow the cover device 10 to shift in the guide groove 22b under the accessory element 3.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A cover device for a rail system, comprising:
a plurality of guide grooves of the rail system; and
a plurality of interconnected and telescoping lamellar segments that at least laterally exhibit a plurality of guide elements adapted to engage the plurality of guide grooves,
wherein the plurality of guide elements are at least partially variable in length, so that an overall width of the cover device transverse to a progression of the plurality of guide grooves are adapted to diminish for removal and insertion from and in the rail system.

2. The cover device according to claim 1, wherein at least one segment of the plurality of interconnected and telescoping lamellar segments comprise an accommodating section on an upper side.

3. The cover device according to claim 2, wherein a lid element is arranged on the accommodating section.

4. The cover device according to claim 1, further comprising a locking device adapted to lock the cover device in the rail system.

5. The cover device according to claim 1, wherein the plurality of interconnected and telescoping lamellar segments at least partially comprise an opaque material.

6. A rail system for a motor vehicle, comprising:
two interacting rail units spaced apart from each other and including facing sides of which have at least one guide groove;
a cover device guided between the two interacting rail units with guide elements in the at least one guide groove, the cover device comprising:
a plurality of guide grooves of the rail system; and
a plurality of interconnected and telescoping lamellar segments that at least laterally exhibit a plurality of guide elements adapted to engage the plurality of guide grooves,
wherein the plurality of guide elements are at least partially variable in length, so that an overall width of the cover device transverse to a progression of the plurality of guide grooves are adapted to diminish for removal and insertion from and in the rail system.

7. The rail system according to claim 6, wherein each rail unit comprises the plurality of guide grooves adapted to guide the cover device in various planes.

8. The rail system according to claim 7, wherein the plurality of guide grooves are spaced apart from a floor area and yield a cargo space between the floor area and rails adapted to at least partially cover by the cover device.

9. The rail system according to claim 6, wherein the rail units exhibit connecting elements for attachment of an accessory.

10. The rail system according to claim 6, wherein at least one segment of the plurality of interconnected and telescoping lamellar segments comprise an accommodating section on an upper side.

11. The rail system according to claim 10, wherein a lid element is arranged on the accommodating section.

12. The rail system according to claim 6, further comprising a locking device adapted to lock the cover device in the rail system.

13. The rail system according to claim 6, wherein the plurality of interconnected and telescoping lamellar segments at least partially comprise an opaque material.

14. A motor vehicle with a passenger compartment, comprising:
two interacting rail units spaced apart from each other and including facing sides of which have at least one guide groove;
a cover device guided between the two interacting rail units with guide elements in the at least one guide groove, the cover device comprising:
a plurality of guide grooves of a rail system; and
a plurality of interconnected and telescoping lamellar segments that at least laterally exhibit a plurality of guide elements adapted to engage the plurality of guide grooves,
wherein the plurality of guide elements are at least partially variable in length, so that an overall width of the cover device transverse to a progression of the plurality of guide grooves are adapted to diminish for removal and insertion from and in the rail system.

15. The motor vehicle according to claim 14, wherein each rail unit comprises the plurality of guide grooves adapted to guide the cover device in various planes.

16. The motor vehicle according to claim 15, wherein the plurality of guide grooves are spaced apart from a floor area and yield a cargo space between the floor area and rails adapted to at least partially cover by the cover device.

17. The motor vehicle according to claim 14, wherein the rail units exhibit connecting elements for attachment of an accessory.

18. The motor vehicle according to claim 14, wherein at least one segment of the plurality of interconnected and telescoping lamellar segments comprise an accommodating section on an upper side.

19. The motor vehicle according to claim 18, wherein a lid element is arranged on the accommodating section.

20. The motor vehicle according to claim 14, further comprising a locking device adapted to lock the cover device in the rail system.
